(19) United States
(12) Patent Application Publication
(10) Pub. No.: US 2002/0042789 A1
(43) Pub. Date: Apr. 11, 2002

(54) Internet search engine with interactive search criteria construction

(76) Inventors: Zbigniew Michalewicz, Charlotte, NC (US); Andrzej Jankowski, Warsaw (PL)

Correspondence Address: McGuire Woods, Suite 1800, 1750 Tysons Boulevard, McLean, VA, 22102-4215, US

(21) Appl. No.: 09/920,739

(22) Filed: Aug. 3, 2001

Related U.S. Application Data
(60) Provisional application No. 60/237,792, filed on Oct. 4, 2000.

(51) Int. Cl. G06F 7/00

(52) U.S. Cl. 707/3; 707/500.1

(57) ABSTRACT

A method and system for searching a document source. The method includes analyzing a query and then creating a query pattern. A document is search in a document source which match the query pattern. The retrieved documents are divided into subsets of similar documents, where each subset of the subsets of similar documents is described in terms of a subset pattern. An ordered list of clusters based on the subset pattern of each subset of similar documents is then retrieved. The ordered list of clusters includes separate clusters which contain similar documents retrieved in response to the query. A machine readable medium containing code for searching a document source is also provided.

### CROSS REFERENCE TO RELATED APPLICATIONS

The present application claims benefit of priority to U.S. provisional application Ser. No. 60/237,792 filed on Oct. 4, 2000 and entitled “Internet Search Engine With Interactive Search Criteria Construction”. The present application is also related to U.S. applications entitled “Spider Technology for Internet Search Engine” (Attorney Docket No. 07100003AA) and “System And Method For Analysis And Clustering of Documents For Search Engine” (Attorney Docket No. 07100004AA), all of which were filed simultaneously with the present application and assigned to a common assignee. The disclosures of these co-pending applications are incorporated herein by reference in their entirety.

### BACKGROUND

1. Field of the Invention

The present invention is generally related to a system and method for searching documents in a data source and more particularly, to a system and method for searching the Internet, the World Wide Web Portion of the Internet, an intranet or other data sources.

### BACKGROUND SECTION

The Internet and the World Wide Web portion of the Internet provide a vast amount of structured and unstructured information in the form of documents and the like. This information may include business information such as, for example, home mortgage lending rates for the top banks in a certain geographical area, and may be in the form of spreadsheets, HTML documents or a host of other formats and applications. Taken in this environment (e.g., the Internet and the World Wide Web portion of the Internet), the information that is now disseminated and retrievable is fast transforming society and the way in which business is conducted, worldwide.

In the environment of the Internet and the World Wide Web portion of the Internet, it is important to understand that information is changing both in terms of volume and accessibility; that is, the information provided in this environment is dynamic. Also, with technological advancement, more and more data in electronic form is being made available to the public. This is partly due to the information being electronically disseminated to the public on a daily basis from both the private and government sectors. In realizing the amount of information now available, corporations and businesses have recognized that one of the most valuable assets in this electronic age is, indeed, the intellectual capital gained through knowledge discovery and knowledge sharing via the Internet and the World Wide Web portion of the Internet. Leveraging this gained knowledge has become critical to gaining a strategic advantage in the competitive worldwide marketplace.

Although increasing amounts of information is available to the public, finding the most pertinent information and then organizing and understanding this information in a logical manner is a challenge to even the most sophisticated user. For example, it is necessary, prior to retrieving information, to

Realize what information is really needed,

How can that information be accessed most efficiently including how quickly can that information be retrieved, and

What specific knowledge would the information provide to the requester and how the requestor (e.g., a business) can gain economically or otherwise from such information.

Undoubtedly, it has thus become increasingly important to devise a sound search strategy prior to conducting a search on the Internet or the World Wide Web portion of the Internet. This enables a business to more efficiently utilize its resources. Accordingly, by devising a coherent search strategy, it may be possible to gather information in order to make it available to a proper person so as to make an informed and educated decision. Without such proper and timely gathered information, it may be impossible or extremely difficult to make a critical and well informed decision.

The existing tools for Internet information retrieval can be classified into three basic categories:

1. Catalogues: In catalogues, data is divided (a priori) into categories and themes. This division is performed manually by a service-redactor (subjective decisions).

For a very large catalogue, there are problems with updates and verification of existing links, hence catalogues contain a relatively small number of addresses. The largest existing catalogue, Yahoo™, contains approximately 1.2 million links.

2. Search engines: Search engines build and maintain their specialized databases. Two main types of software is necessary to build and maintain such databases. First, a program is needed to analyze the text of documents found on the World Wide Web (WWW) to store relevant information in the database (so-called index), and to follow further links (so-called spiders or crawlers). Second, a program is needed to handle queries/answers to/from the index.

3. Multi-search tools: These tools usually pass the request to several search engines and prepare the answer and one (combined) list. These services usually do not have any “indexes” or “spiders”; they just sort the retrieved information and eliminate redundancies.

The current Internet search engines analyze and index documents in different ways.

However, these search engines usually define the theme of a document and its significance (the latter one influences the position (“ranking”) of the document on the answer page) as well as select keywords by analyzing the placement and frequencies of the words and weights associated with the words. Additionally, current search engines use additional “hints” to define the significance of the document (e.g., the number of other links pointing to the document). The current Internet search engines also incorporate some of the following features:

Keyword search—retrieval of documents which include one of more specified keywords.

Boolean search—retrieval of documents, which include (or do not include) specified keywords. To achieve this effect, logical operators (e.g., AND, OR, and NOT) are used.

Concept search—retrieval of documents which are relevant to the query, however, they need not contain specified keywords.

Phrase search—retrieval of documents which include a sequence of words or a full sentence provided by a user usually between delimiters;

Proximity search—retrieval of documents where the user defines the distance between some keywords in the documents.

Thesaurus—a dictionary with additional information (e.g., synonyms). The synonyms can be used by the search engine to search for relevant documents in cases where the original keywords are missing in the documents.

Fuzzy search—retrieval method for checking incomplete words (e.g., stems only) or misspelled words.

Query-By-Example—retrieval of documents which are similar to a document already found.

Stop words—words and characters which are ignored during the search process.

During the presentation of the results, apart form the list of hits (Internet links) sorted in appropriate ways, the user is often informed about the values of additional parameters of the search process. These parameters are known as precision, recall and relevancy. The precision parameter defines how returned documents fit the query. For example, if the search returns 100 documents, but only 15 contain specified keywords, the value of this parameter is 15%. The recall parameter defines how many relevant documents were retrieved during the search. For example, if there are 100 relevant documents (i.e., documents containing specified keywords) but the search engine finds 70 of these, the value of this parameter would be 70%. Lastly, the relevance parameter defines how the document satisfies the expectations of the user. This parameter can be defined only in a subjective way (by the user, search redactor, or by a specialized IQ program).

Now, the conventional search engine attempts to find and index as many websites as possible on the World Wide Web by following hyperlinks, wherever possible. However, these conventional search engines can only index the surface web pages that are typically HTML files. By this process, only pages that are static HTML files (probably linked to other pages) are discovered using the keyword searches. But not all web pages are static HTML files and, in fact, many web pages that are HTML files are not even tagged accurately to be detectable by the search engine. Thus, search engines do not even come remotely close to indexing the entire World Wide Web (much less the entire Internet), even though millions of web pages may be included in their databases.

It has been estimated that there are more than 100,000 web sites containing un-indexed buried pages, with 95 percent of their content being publicly accessible information. This vast repository of information, hidden in searchable databases that conventional search engines cannot retrieve, is referred to as the “deep Web”. While much of the information is obscure and useful to very few people, there still remains a vast amount of data on the deep Web. Not only is the data on the deep Web potentially valuable, it is also multiplying faster than data found on the surface Web. This data may include, for example, scientific research which may be useful to a research department of a pharmaceutical or chemical company, as well as financial information concerning a certain industry and the like. In any of these cases, and countless more, this information may represent valuable knowledge which may be bought and sold over the Internet or World Wide Web, if it was known to be available.

With the recent Internet boom, the number of servers has risen to more than 18 million. The number of domains has grown from 4.8 million in 1995 to 72.4 million in 2000. The number of web pages indexed by search engines has risen from 50 million in 1995 to approximately 2.1 billion in 2000. Meanwhile, the deep Web, with innumerable web pages not indexable by search engines, has grown to about 17,500 terabytes of information consisting of over 500 billion documents. Obviously, advanced mechanisms are necessary to discover all this information and extract meaningful knowledge for various target groups. Unfortunately, the current search engines have not been able to meet these demands due to drawbacks such as, for example, (i) the inability to access the deep Web, (ii) irrelevant and incomplete search results, (iii) information overload experienced by users due to the inability of being able to narrow searches logically and quickly, (iv) display of search results as lengthy lists of documents that are laborious to review, (v) the query process not being adaptive to past query/user sessions, as well as a host of other shortcomings.

Discovery engines, on the other hand, help discover information when one is not exactly sure of what information is available and therefore is unable to query using exact keywords. Similar to data mining tools that discover knowledge from structured data (often in numerical form), there is obviously a need for “text-mining” tools that uncover relationships in information from unstructured collection of text documents. However, current discovery engines still cannot meet the rigorous demands of finding all of the pertinent information in the deep Web, for a host of known reasons. For example, traditional search engines create their card catalogs by crawling through the “surface” Web pages. These same search engines can not, however, probe beneath the surface the deep Web.

### SUMMARY

According to the invention, a method is provided for searching a document source.

The method includes providing a query and analyzing the query in order to create a query pattern. A document source is then searched for documents which match the query pattern. The retrieved documents are divided into subsets of similar documents, where each subset of the subsets of similar documents is described in terms of a subset pattern. An ordered list of clusters is provided based on the subset pattern of each subset of similar documents. The ordered list of clusters includes separate clusters which contain similar documents retrieved in response to the query.

In embodiments, the separate clusters are provided to a user and a log is provided for each of the separate clusters, once requested by the user. The searching may include parsing and interpreting words or documents in the document source. The query pattern may include Boolean functions built from atomic formulas (words or phrases) where variables are phrases of text. Each query pattern may represent a set of documents, where the query pattern is “true”. Also, the subset pattern of each subset of similar documents may be selected from the group comprising:

(i) a ‘logical or’ of two patterns;

(ii) a ‘logical and’ of two patterns;

(iii) a ‘logical difference’ of two patterns;

(iv) a ‘logical or’ of a pattern and a string;

(v) a ‘logical and’ of a pattern and a string; or

(vi) a ‘logical difference’ between a pattern and a string.

A system is also provided for searching a document source. Additionally, a machine readable medium containing code for searching a document source is also provided. The machine readable code may implement the steps of the method of the present invention.

### BRIEF DESCRIPTION OF THE DRAWINGS

FIG. 1 is a block diagram of an exemplary system used with the system and method of the present invention;

FIG. 2 shows the system of FIG. 1 with additional utilities;

FIG. 3 shows an architecture of an Enterprise Web Application;

FIG. 4 shows a deployment of the system of FIG. 1 on a Java 2 Enterprise Edition (J2EE) architecture;

FIG. 5 shows a block diagram of the dialog control module of the present invention;

FIG. 6 is a flow diagram implementing the steps of the present invention;

FIG. 7 shows a design consideration associated with the implementation of the present invention

FIG. 8 shows the Dialog Control (DC) module divided into two layers;

FIG. 9 shows the general data and control flow diagram for the Dialog Control (DC) module;

FIG. 10 shows a main use case diagram of the present invention;

FIG. 11 is a flow diagram showing the sequence of events as described with reference to FIG. 10;

FIG. 12 shows a package diagram for the controller package shown in FIG. 5;

FIG. 13 shows a package diagram for the events package shown in FIG. 5; and

FIG. 14 shows a flow diagram of diagram Interaction Process Request.

### DETAILED DESCRIPTION OF INVENTION

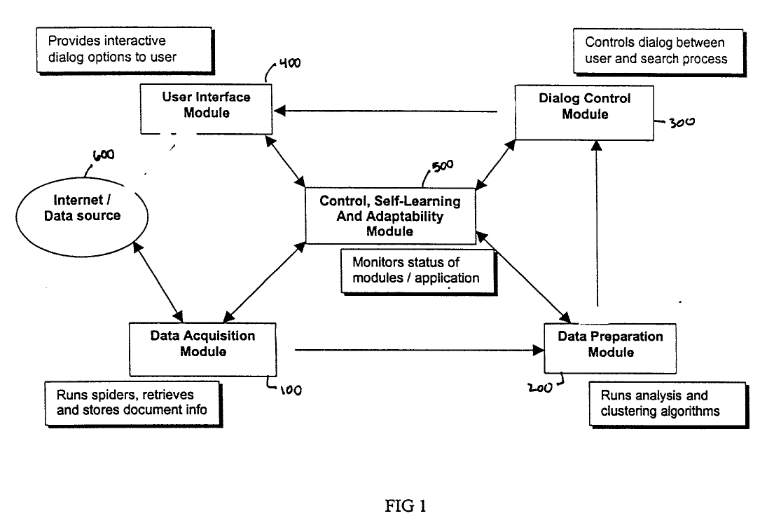

FIG. 1 represents an overview of an exemplary search, retrieval and analysis application which may be used to implement the method and system of the present invention. It should be recognized by those of ordinary skill in the art that the system and method of the present invention may equally be implemented over a host of other application platforms, and may equally be a standalone module. Accordingly, the present invention should not be limited to the application shown in FIG. 1, but is equally adaptable as a stand alone module or implemented through other applications, search engines and the like.

The overall system shown in FIG. 1 includes five innovative modules: (i) Data Acquisition (DA) module 100, (ii) Data Preparation (DP) module 200, (iii) Dialog Control (DC) module 300, (iv) User Interface (UI) module 400, and (v) Adaptability, Self-Learning and Control (ASLC) module 500, with the Dialog Control (DC) module 300 implementing the system and method of the present invention. For purposes of this discussion, the Data Acquisition (DA) module 100, Data Preparation (DP) module 200, User Interface (UI) module 400, and Adaptability, Self-Learning and Control (ASLC) module 500 will be briefly described in order to provide an understanding of the overall exemplary system; however, the present invention is directed more specifically to innovations associated with the Dialog Control (DC) module 300.

In general, the Data Acquisition module 100 acts as web crawlers or spiders that find and retrieve documents from a data source 600 (e.g., Internet, intranet, file system, etc.). Once the documents are retrieved, the Data Preparation module 200 then processes the retrieved documents using analysis and clustering techniques. The processed documents are then provided to the Dialog Control module 300 which enables an intelligent dialog between an end user and the search process, via the User Interface module 400. During the user session, the User Interface module 400 sends information about user preferences to the Adaptability, Self-Learning & Control module 500. The Adaptability, Self-Learning & Control module 500 may be implemented to control the overall exemplary system and adapt to user preferences.

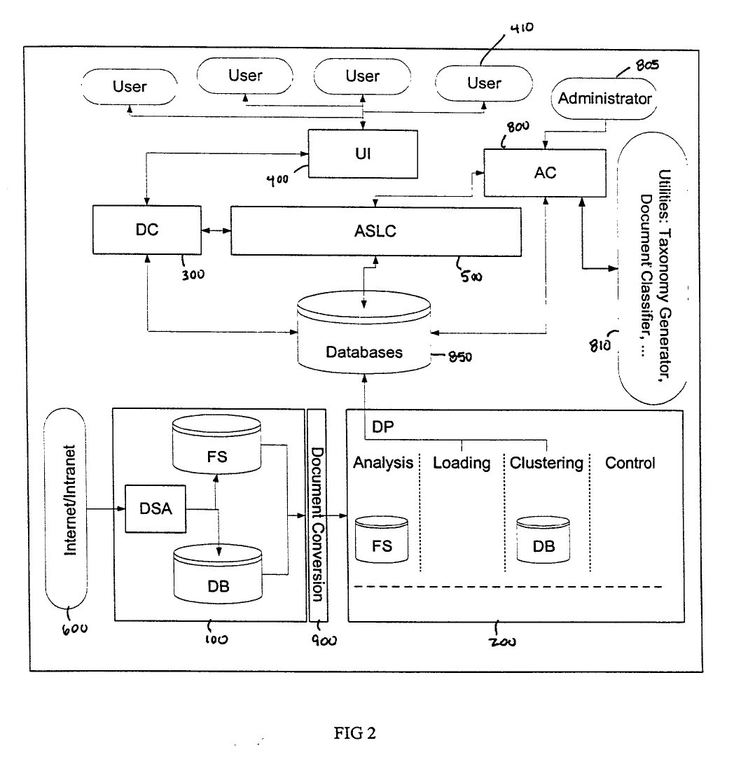

FIG. 2 shows the system of FIG. 1 with additional utilities: Administration Console (AC) 800 and Document Conversion utility 900. After the Data Acquisition module 100 receives documents from the Internet or other data source 600, the Document Conversion utility 900 converts the documents from various formats (such as MS Office documents, Lotus Notes documents, PDF documents and others) into HTML format. The HTML formatted document is then stored in a database 850. The stored documents may then be processed in the Data Preparation module 200, and thereafter provided to the User Interface module 400 via the database 850 and the Dialog Control module 300. Several users 410 may then view the searched and retrieved.

The Administration Console 800 is a configuration tool for system administrators 805 and is associated with a utilities module 810 which is capable of, in embodiments, taxonomy generation, document classification and the like. The Data Acquisition module 100 provides for data acquisition (DA) and includes a file system (FS) and a database (DB). The DA is designed to supply documents from the Web or user FS and update them with required frequency. The Web is browsed through links that have been found in already downloaded documents. The user preferences can be adjusted using console screens to include domains of interest chosen by user. This configuration may be performed by Application Administrator.

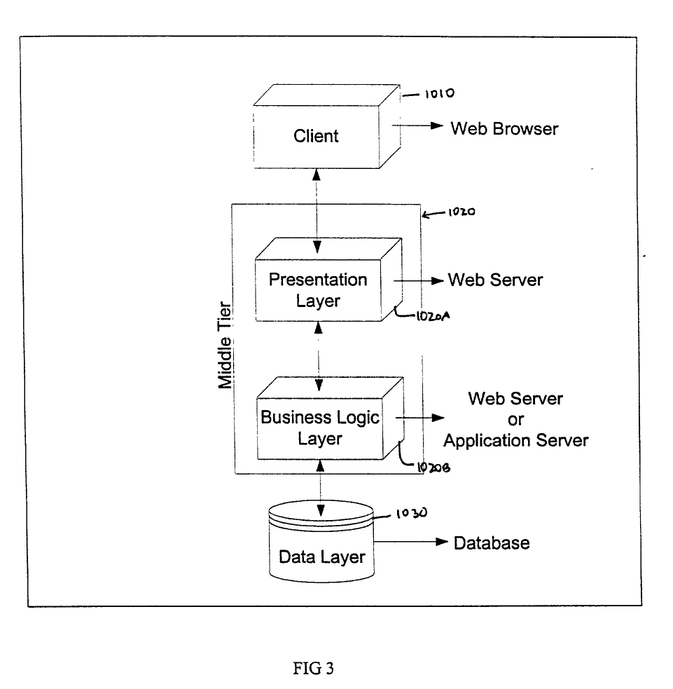

FIG. 3 shows a typical architecture of an Enterprise Web Application. This architecture, generally depicted as reference numeral 1000, includes four layers: a Client layer (Browser) 1010, a middle tier 1020 including a Presentation layer (Web Server) 1020A and a Business Logic layer (Application Server) 1020B, and a Data layer (Database) 1030. The Client layer (Browser) 1010 renders the web pages. The Presentation layer (Web Server) 1020A interprets the web pages submitted from the client and generates new web pages, and the Business Logic layer (Application Server) 1020B enforces validations and handles interactions with the database. The Data layer (Database) 1030 stores data between transactions of a Web-based enterprise application.

More specifically, the client layer 1010 is implemented as a web browser running on the user's client machine. The client layer 1010 displays data and allows the user to enter/update data. Broadly, one of two general approaches is used for building the client layer 1010:

A “dumb” HTML-only client: with this approach, virtually all the intelligence is placed in the middle tier. When the user submits the webpages, all the validation is done in the middle tier and any errors are posted back to the client as a new page.

A semi-intelligent HTML/Dynamic HTML/JavaScript client: with this approach some intelligence is included in the webpage which runs on the client. For example, the client will do some basic validations (e.g. ensure mandatory columns are completed before allowing the submit, check numeric columns are actually numbers, do simple calculations, etc.) The client may also include some dynamic HTML (e.g. hide fields when they are no longer applicable due to earlier selections, rebuild selection lists according to data entered earlier in the form, etc.) Note: client intelligence can be built using other browser scripting languages

The dumb client approach may be more cumbersome for end-users because it must go back-and-forth to the server for the most basic operation. Also, because lists are not built dynamically, it is easier for the user to inadvertently specify invalid combinations of inputs (and only discover the error on submission). The first argument in favor of the dumb client approach is that it tends to work with earlier versions of browsers (including non-mainstream browsers). As long as the browser understand HTML, it will generally work with the dumb client approach. The second argument in favor of the dumb client approach is that it provides a better separation of business logic (which should be kept in the business logic tier) and presentation (which should be limited to presenting the data). Including Dynamic HTML and JavaScript in the Presentation (so it can run on the client) mixes the tiers.

The semi-intelligent client approaches are generally easier-to-use and require fewer communications back-and-forth from the server. Generally, Dynamic HTML and JavaScript is written to work with later versions of mainstream versions (a typical requirement: must have IE 4 or later or Netscape 4 or later). Since the browser market has gravitated to Netscape™ and IE and the version 4 browsers have been available for 3 years, this requirement is generally not too onerous. More and more websites are specifying the version 4 or later of IE/Netscape™ browser requirement. In the present invention, the use of HTML-only client is preferred.

The presentation layer 1020A generates webpages and includes dynamic content in the webpage. The dynamic content typically originates from a database (e.g. a list of matching products, a list of transaction conducted over the last month, etc.) Another function of the presentation layer 1020A is to “decode” the webpages coming back from the client (e.g. find the user-entered data and pass that information onto the business logic layer). The presentation layer 1020A is preferably built using the Java solution using some combination of Servlets and JavaServer Pages (JSP). The presentation layer 1020A is generally implemented inside a Web Server (like Microsoft IIS, Apache WebServer, IBM Websphere, etc.) The Web Server can generally handle requests for several applications as well as requests for the site's static webpages. Based on its initial configuration, the web server knows which application to forward the client-based request to (or which static webpage to serve up).

A majority of the application logic is written in the business logic layer 1020B. The business logic layer 1020B includes:

performing all required calculations and validations,

managing workflow (including keeping track of session data),

managing all data access for the presentation tier

In modern web applications, business logic layer 1020B is frequently built using:

Microsoft solution where COM object are built using with Visual Basic or C++

Java solution where Enterprise Java Beans (EJB) are built using Java.

Language-independent CORBA objects can also be built and easily accessed with a Java Presentation Tier.

The business logic layer 1020B is generally implemented inside an Application Server (like Microsoft MTS, Oracle Application Server, IBM Websphere, etc.) The Application Server generally automates a number of services such as transactions, security, persistence/connection pooling, messaging and name services. Isolating the business logic from these “house-keeping” activities allows developer to focus on building application logic while application server vendors differentiate their products based on manageability, security, reliability, scalability and tools support.

The data layer 1030 is responsible for managing the data. In a simple example, the data layer 1030 may simply be a modem relational database. However, the data layer 1030 may include data access procedures to other data sources like hierarchical databases, legacy flat files, etc. The job of the data layer is to provide the business logic layer with required data when needed and to store data when requested.

Generally speaking, the architect of FIG. 3 should aim to have little or no validation/business logic in the data layer 1030 since that logic belongs in the business logic layer. However, eradicating all business logic from the data tier is not always the best approach. For example, not null constraints and foreign key constraints can be considered “business rules” which should only be known to the business logic layer.

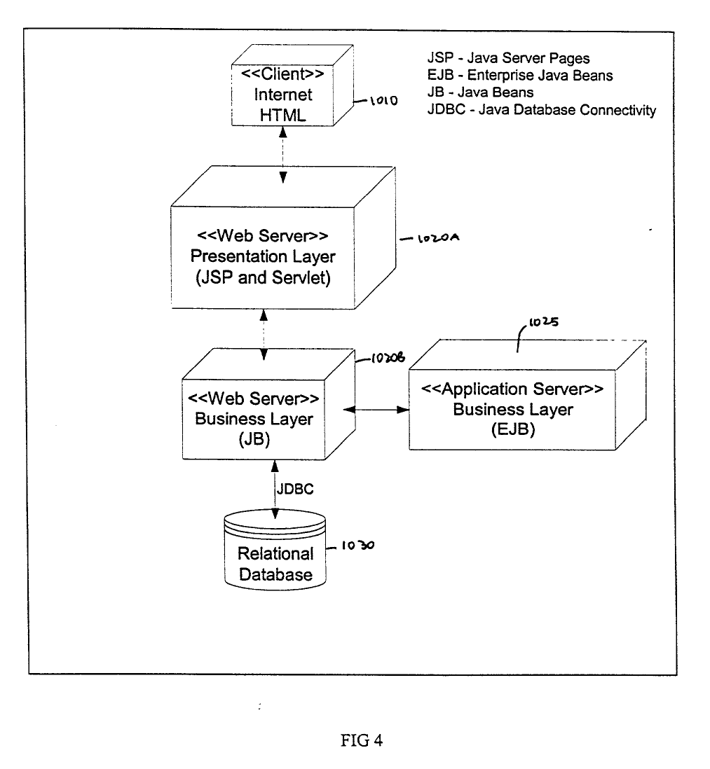

FIG. 4 shows the deployment of the system of FIG. 1 on a Java 2 Enterprise Edition (J2EE) architecture. The system of FIG. 4 uses an HTML client 1010 that optionally runs JavaScript. The Presentation layer 1020A is built using Java solution with a combination of Servlets and Java Server Pages (JSP) for generating web pages with dynamic content (typically originating from the database). The Presentation layer 1020A may be implemented within an Apache™ Web Server. The Servlets/JSP that run inside the Web Server may also parse web pages submitted from the client and pass them for handling to Enterprise Java Beans (EJBs) 1025. The Business Logic layer 1020B may also be built using the Enterprise Java Beans and implemented inside the Web Server. (Note that the Business Logic layer 1020B may also be implemented within an Application Server). EJBs are responsible for validations and calculations, and provide data access (e.g., database I/O) for the application. EJBs access, in embodiments, an Oracle™ database through a JDBC™.

JDBC™ technology is an Application Programming Interface (API) that allows access to virtually any tabular data source from the Java programming language. JDBC provides cross-Database Management System (DBMS) connectivity to a wide range of Structured Query Language (SQL) databases, and with the JDBC API, it also provides access to other tabular data sources, such as spreadsheets or flat files. The JDBC API allows developers to take advantage of the Java platform's “Write Once, Run Anywhere”™ capabilities for industrial strength, cross-platform applications that require access to enterprise data. With a JDBC technology-enabled driver, a developer can easily connect all corporate data even in a heterogeneous environment. The data layer is preferably an Oracle™ relational database.

In one preferred embodiment, the platform for the database is Oracle 81 running on either Windows NT 4.0 Server or Oracle 8I Server. The hardware may be an Intel Pentium 400 Mhz/256 MB RAM/3 GB HDD. The web server may be implemented using Windows NT 4.0 Server, IIS 4.0 and a firewall is responsible for security of the system. It provides secure access to web servers. The system may run on Windows NT 4.0 Server, Microsoft Proxy 3.

Data Acquisition Module

In general, the Data Acquisition module 100 includes intelligent “spiders” which are capable of crawling through the contents of the Internet, Intranet or other data sources 600 in order to retrieve textual information residing thereon. The retrieved textual information may also reside on the deep Web of the World Wide Web portion of the Internet. Thus, an entire source document may be retrieved from web sites, file systems, search engines and other databases accessible to the spiders. The retrieved documents may be scanned for all text and stored in a database along with some other document information (such as URL, language, size, dates, etc.) for further analysis.

The spiders may be parameterized to adapt to various sites and specific customer needs, and may further be directed to explore the whole Internet from a starting address specified by the administrator. The spider may also be directed to restrict its crawl to a specific server, specific website, or even a specific file type. Based on the instruction it receives, the spider crawls recursively by following the links within the specified domain. An administrator is given the facility to specify the depth of the search and the types of files to be retrieved. The entire process of data acquisition using the spiders may be separate from the analysis process.

Data Preparation Module

The Data Preparation module 200 analyzes and processes documents retrieved by the Data Acquisition module 100. The function of this module 200 is to secure the infrastructure and standards for optimal document processing. By incorporating Computational Intelligence (CI) and statistical methods, the document information is analyzed and clustered using novel techniques for knowledge extraction as discussed in detail in the co-pending simultaneously filed U.S. application Ser. No. ______, entitled “System And Method For Analysis and Clustering of Documents for Search Engine” (Attorney Docket No. 07100004AA) and incorporated by reference in its entirety herein. It is noted that other well known techniques may also be used for data acquisition.

A comprehensive dictionary is built based on the keywords identified by the these (or other) techniques from the entire text of the document, and not on the keywords specified by the document creator. This eliminates the scope of scamming where the creator may have wrongly meta-tagged keywords to attain a priority ranking. The text is parsed not merely for keywords or the number of its occurrences, but the context in which the word appeared. The whole document is identified by the knowledge that is represented in its contents. Based on such knowledge extracted from all the documents, the documents are clustered into meaningful groups (as a collective representation of the desired information) in a catalog tree in the Data Preparation Module 200. This is a static type of clustering; that is, the clustering of the documents do not change in response to a user query (as compared to the clustering which may be performed in the Dialog Control module 300, discussed below). The results of document analysis and clustering information are stored in a database that is then used by the Dialog Control module 300.

Dialog Control Module

The Dialog Control module 300 offers an intelligent dialog between the user and the search process; that is, the Dialog Control module 300 allows interactive construction of an approximate description of a set of documents requested by a user. Using the knowledge built by the Data Preparation module 200, based on optimal document representation, the user is presented with clusters of documents that guide the user in logically narrowing down the search in a top-down manner. This mechanism expedites the search process since the user can exclude irrelevant sites or sites of less interest in favor of more relevant sites that are grouped within a cluster. In this manner, the user is precluded from having to review individual sites to discover their content since that content would already have been identified and categorized into clusters. The function of the Dialog Control module 300 may thus support the user with tools that enable an effective construction of the search query within the scope of interest. The Dialog Control module 300 may also be responsible for content-related dialog with the user.

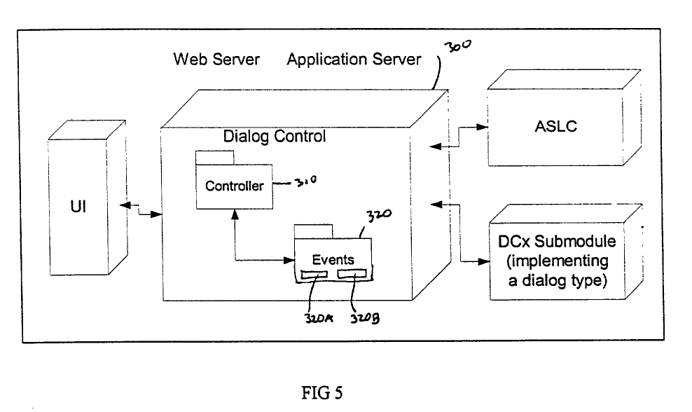

FIG. 5 shows a block diagram of the Dialog Control module 300. The Dialog Control module 300 includes a controller module (package) 310 and an events module (package) 320. The controller module 310 controls the data flow, and the events module 320 allows data objects to be passed between the User Interface 400 and the Dialog Control module 300. The events module 310 may include a Pattern module 320A and a Clustering module 320B.

The Pattern module 320A allows the user's requests to be described as Boolean functions (called patterns) built from atomic formulas (words or phrases) where the variables are phrases of text. For example, a pattern may be represented as:

[‘Banach’ AND (‘theorem’ OR ‘space’)] OR ‘analytical function’

Every pattern represents a set of documents, where the pattern is “true”. In the simplest form, a pattern may be defined as any set of words (so-called standard pattern). For example, the pattern W is present in the document D if all words from W appear in D. The Dialog Control module 300 retrieves standard patterns, which characterise the query. These standard patterns are returned as possibilities found by the system.

The Pattern module 320A may be implemented, for example, by a set of five classes, including Pattern and subclasses Phrase, Or, And, and Neg. The following code illustrates the use of these classes.

void main()
{
Pattern *P = new Pattern();

Phrase fraza(“Project”);

char T[256]=“”;

P = &(fraza * “House”);

P = &(*P − “Construction”);

printf(P−>Pat2Text(T));
}

The result of this function is the message: “Project *House-Construction”

The Clustering module 320B, on the other hand, provides communication needs between the graphical User Interface 400 and the Dialog Control module 300. On the basis of the dialog with the user, the graphical User Interface 400 receives a user's query which is then transferred into the pattern. At this stage the graphical User Interface 400 calls the function “Clustering”, where one of the parameters is the created pattern. The result is a list of clusters, which is displayed in the dialog window as the result of the search. The Clustering module 302B may be implemented, for example, by a set of five classes:

1. WordStat

2. WordLis

3. DocumentSet

4. Cluster

5. ClusterList

Altogether, the components of the Dialog Control module 300 for communication with other modules may additionally include:

Function “Clustering”: Responsible for grouping of documents satisfying a user's requirements.

Class “Pattern”: Responsible for description of patterns and operations on patterns.

Class “Cluster”: Responsible for storing information on similar documents.

Class “ClusterList”: Responsible for storing information on lists of similar documents.

Function “Clustering”

The function “Clustering” may be implemented according to the following method: ClusterList *Clustering (Pattern *wzorzec, int MaxClNo, int MaxClSize). The parameter “wzorzec” is a description of a user's request. The parameter “MaxClNo” is a maximum number of clusters, and the parameter “MaxClSize” is a maximum number of documents in one cluster.

Class “Pattern”

For objects of this class, the following methods are available:

Pattern &operator+(Pattern &P): This operator allows creation of a new pattern being a ‘logical or’ of two patterns.

Pattern &operator*(Pattern &P): This operator allows creation of a new pattern being a ‘logical and’ of two patterns.

Pattern &operator−(Pattern &P): This operator allows creation of a new pattern being a ‘logical difference’ of two patterns.

Pattern &operator+(char *Ptr): Returns ‘logical or’ of a pattern and a string.

Pattern &operator*(char *Ptr): Returns ‘logical and’ of a pattern and a string.

Pattern &operator−(char *Ptr): Returns ‘logical difference’ between a pattern and a string.

new(char *Str): Creates a new pattern.

char *Pat2Text(char *text): Converts a pattern into a text. The assumption is that the variable ‘text’ is a pointer to a string.

Class “Cluster”

This class is used to store information on properties of a group of documents; these include the pattern of these documents, the number of documents, pointers to documents, etc. The available functions may include:

Pattern *GetPattern( ): Returns pointer to the pattern describing the cluster

int GetSize( ): Returns the number of documents within a cluster

int GetDocIndex(int Num): Returns an index of the document with a number Num within a cluster.

Class “ClusterList”

This class is used to store information on the list of clusters. The following functions are available:

int GetClusterNumber( ): Returns the number of clusters

Cluster *GetCluster(int i): Returns pointer to the i-th cluster.

Now, in use the requestor (user) formulates a query as a set T of words, which should appear in the retrieved documents. The Dialog Control module 300 replies in two steps:

(i) It retrieves all documents DOC(T) which include words from T.

(ii) It groups the retrieved documents into similarity clusters and returns to the user standard patterns of these groups.

After these steps, the user may construct a new query (taking advantage from the results of the previous query and the standard patterns already found). It is expected that the new query is more precise and better describes the user's requirements.

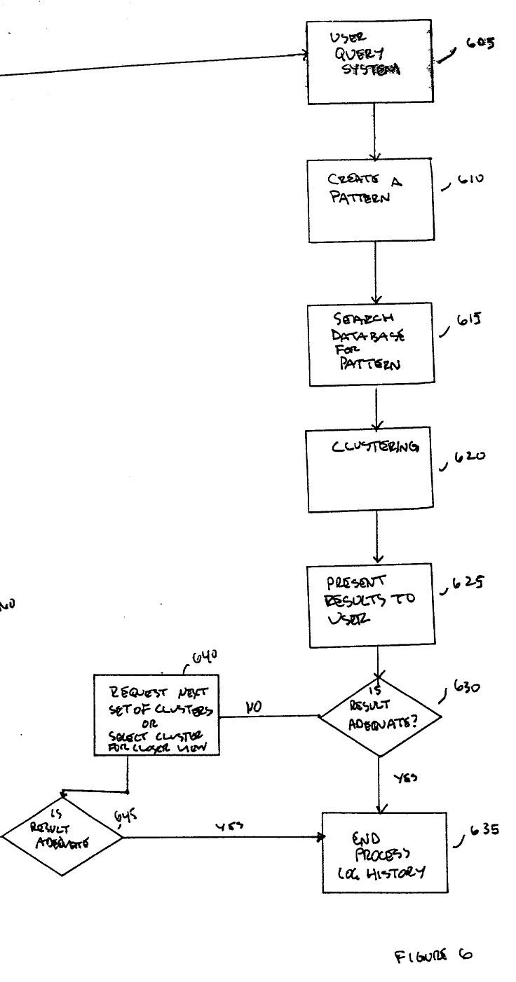

Being even more specific, FIG. 6 is a flow diagram showing the steps of implementing the method of the present invention. The steps of the present invention may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network. FIG. 6 may equally represent a high level block diagram of the system of the present invention, implementing the steps thereof.

In step 605, the user identifies keywords or presents a complete query (e.g., house AND project). The documents will be retrieved (from the database) on the basis of these keywords (index match). In step 610, the query and/or keywords are analyzed and a “pattern” is created. In step 615, the database is searched for documents which match the pattern. In step 620, the retrieved documents are divided into subsets of similar documents, where each subset is described by its own pattern. In other words, the process creates an ordered list of clusters. In step 625, the user is provided with an initial solution proposal.

In step 630, a determination is made as to whether the solution is responsive to the user's query. If responsive, the process stops at step 645 and the history is logged in a database upon the conclusion of each user dialog session. If not responsive, the user either requests a next set of clusters or selects a proposed cluster for a closer view of the documents contained within such cluster, in step 640. It is also possible for the user to ask for documents from a specified combination of clusters. If the result is then determined to be adequate, in step 645, the history is logged in a database upon the conclusion of each user dialog session. If not, the process may return to step 605 so that the user can then formulate another (possibly more specific) query.

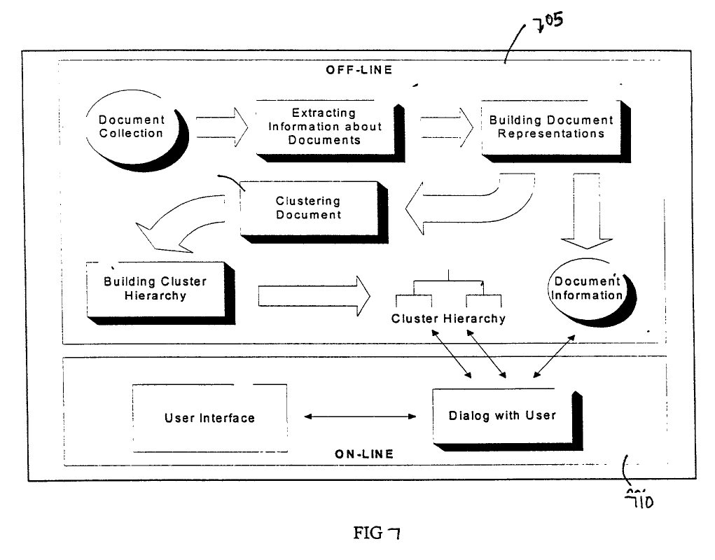

FIG. 7 shows a design consideration for implementing the method and system of the present invention. In an offline mode 705, the following procedures are implemented: document collection, information extraction, document representation and information, and clustering hierarchy. In the on-line mode 710, there is an interaction between the user and the user interface, as well as the cluster hierarchy and the document information. Thus, according to the design consideration of FIG. 7, while the dialog with the user is maintained on-line, the remaining portions of the process are kept off-line. In this manner, the user will not experience a lag in the response time due to the analysis and clustering of the documents.

The Dialog Control (DC) module 300 is the part of the system responsible for the dialog with the user. The Dialog Control (DC) module 300 interprets user requests, and processes such requests in a human-friendly manner (i.e., allowing to reach all needed information, but not flooding the user with too much data). This is performed by increasing the number of dialog steps (as compared to a single-step query-and-browse-the-results model currently used in search engines). The Dialog Control (DC) module 300 also decreases the quantity of information presented in each step, making it more friendly for a human, as well as fitting well into human communication-oriented nature.

The Dialog Control (DC) module 300 is, in embodiments, the logical layer connecting the graphical User Interface 400 environment with the pre-processed document data stored in the system. The Dialog Control (DC) module 300 is responsible for all on-line data processing in the system, and is part of the system that executes the document searching.

One of several goals of the Dialog Control (DC) module 300 is to allow many different data preparation strategies and dialog variants using the same general dialog outline. These requirements may be, for example,

high scalability and performance (thousands of users being served concurrently),

flexible, strong and human-oriented dialog (it must introduce some kind of consistency and similarity in dialogs offered by different subsystems).

architecture that ensures separation of User Interface and Data Preparation modules,

portability: it should be possible to run the module in as many as possible popular hardware and software environments.

The Dialog Control (DC) module 300 preferably does not interact directly with the user. Presentation of the results and capturing of user actions is preferably performed by the User Interface 400, which collaborates with the Dialog Control (DC) module 300. The Dialog Control (DC) module 300 also does not preferably process original HTML documents data collected by the Data Storage & Acquisition module. Instead, the Dialog Control (DC) module 300 processes data prepared by the Data Preparation module. (The Data Preparation module preferably does the “heavy processing” performed off-line due to time and performance constraints; whereas, the Dialog Control (DC) module 300 executes light, on-line processing of the Data Preparation results.) In general, the Dialog Control (DC) module 300 describes some dialog standards and gives a framework that makes subsystems integration easier. Dialog algorithms are implemented by concrete implementations of Dialog Control in subsystems.

The Dialog Control (DC) module 300 is capable of providing the following functions:

Parsing and interpreting user actions reported by the User Interface module (query interpretation).

Processing data delivered by the Data Preparation module and returning the results (query processing).

Changing user preferences for the dialog.

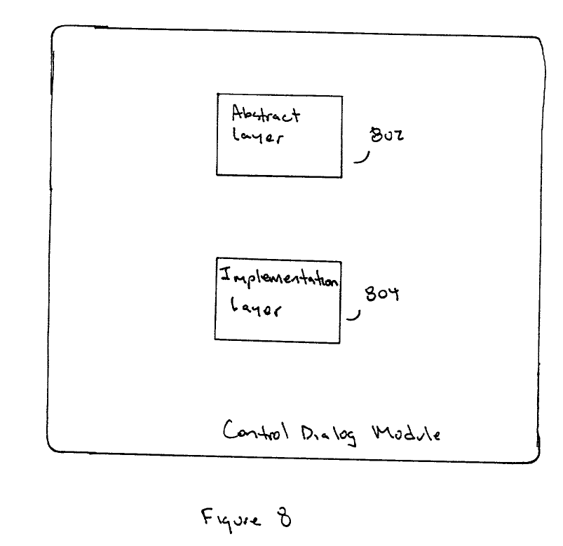

In the preferred embodiment, the Dialog Control (DC) is logically divided into two layers as shown in FIG. 8. That is, there is an Abstract Layer 802 and an Implementation Layer 804. The Abstract Layer 802 defines the dialog outline, implements the interface with the User Interface 400 (also referred interchangeably as “UI”) and with the Implementation Layer 804. The Implementation Layer 804 implements algorithms for the dialog and processing the data delivered by the Data Preparation module (i.e. parses and executes user requests).

The Dialog Control (DC) module 300 preferably uses the Model-View-Controller architecture (MVC). MVC framework is well known in the OO design community for its strength in handling interactions. MVC can be described generally in the following manner for illustrative purposes; however, it should be recognized that one of ordinary skill in the art would readily know how to implement the MVC. Assume that an abstract object (e.g., tree) is to be presented for the user and the user is allowed to interactively change the object (add or delete nodes, etc.). Of course, all changes should be immediately presented, i.e., the internal state of the object and its representation for the user should remain consistent. MVC contains three parts:

Model—the abstract object that we want to present (e.g. tree or business logic),

View—the visual representation of the model,

Controller—responsible for controlling the model—e.g. changing it, etc.

Interactions between these three are simple. The Model does not know anything about the View or the Controller; it simply delivers some methods (for changing itself, etc.). After any change of the state of the Model, it notifies the change sending an event to all objects that registered in the Model their interest in such changes. The View does know its Model and registers in the Model as interested in Model changes. The View is also the only part of the MVC that has direct contact with the user. It captures actions of the user and reports them as requests to the Controller (so the View must know also the Controller). The Controller does not need to know the View. It simply handles requests received. It translates these events to actions on the Model and performs these actions. So, the Controller has to know its Model.

In the Dialog Control (DC) module 300, MVC may be, for example, implemented in the following manner:

| Part of the MVC | Appropriate Part of the Inferno |
|---|---|
| Model | The DC Module Implementation |
| | Layer |
| View | The User Interface Module |
| Controller | The DC Module Abstract Layer |

The original MVC architecture may be slightly modified to separate user interface from the Model. For example, in the present implementation, the Controller is the intermediary in the communication from the Model to the View.

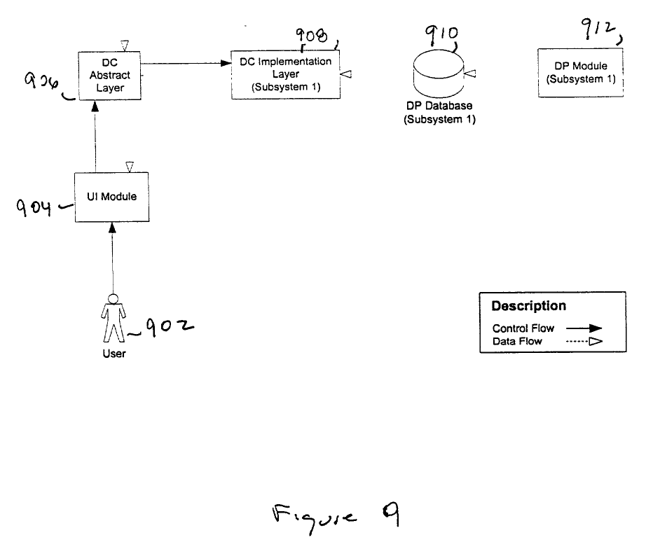

The general data and control flow diagram for the Dialog Control (DC) module 300 is shown in FIG. 9. Control flows on the diagram assume implicit data flows (passing parameters). The information about interactions ordering or any other time-dependencies is not shown in the diagram. Specifically, the control flows from the user 902 through the User Interface 400 at block 904 to the Data Control Abstract layer 802 at block 906. The flow of control information then proceeds into the Data Control Implementation Layer 804 at block 908. On the other hand, data flows in a reverse order: from the Data Preparation module (at block 912) through the Data Preparation database (at block 910) and then through the Data Control Implementation and Abstract layers (at blocks 908 and 906) and to the User Interface 400 (at block 904).

The Dialog Control (DC) module 300 working scenario may include:

1. Setting of the dialog subsystem (i.e. the implementation layer) depending on UI information (user preferences),

2. Passing the user action from UI to the subsystem,

3. Processing of the action by the implementation layer,

4. Passing an answer from the subsystem to UI,

5. Repeating of steps 3 and 4 until the end of the dialog, and

6. Closing the subsystem.

The search engine of the present invention is designed to make searching for the required web page more effective and human-friendly. The way to provide this functionality is to make the dialog (between the user and the engine) more intensive. In accordance with this objective (and as previously described), dividing classical single-step dialogs into many steps reduces the amount of information to be processed by the human in each step. To create any dialog with the user and to provide the user with a chance to find anything, the following should be provided:

crawl the Web and collect some information about found pages (or even contents of pages),

do some heavy processing on the collected data to make on-line interactions with the user as fast and adequate as possible,

be able to interpret the user's queries and give him/her appropriate answers using collected and processed data,

be able to communicate with the user.

These functions provide a division of the whole search engine of the present invention into four basic modules: the Spider, the Data Preparation, the Dialog Control and the User Interface 400 (as discussed above). The Dialog Control (DC) module 300 may be, in embodiments, located on the search engine on-line server. The Dialog Control (DC) module 300 controls other modules on the server, and handles user requests. The general requirements of the Dialog Control (DC) module 300 include:

design independent from other modules with well-defined interfaces with them,

minimize remote calls between WWW server and application server, and

remove useless objects—“timeout”.

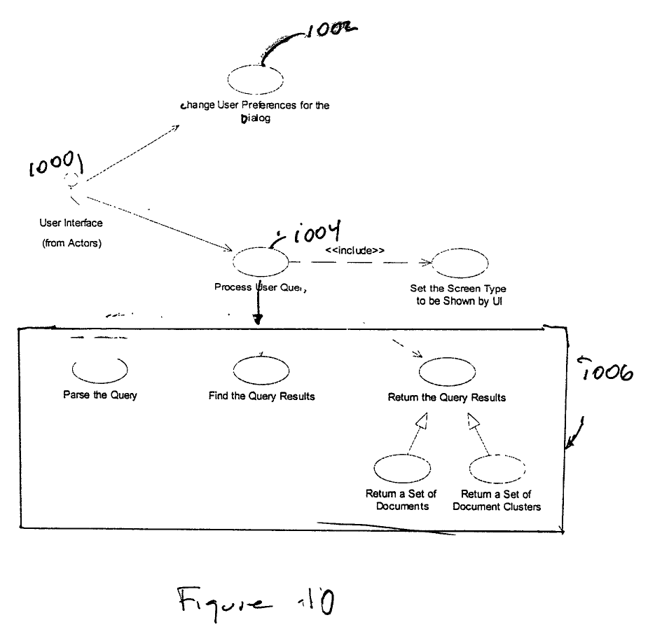

FIG. 10 shows a main use case diagram of the present invention. In FIG. 10, the Dialog Control (DC) module 300 handles user requests relayed from the User Interface. The Dialog Control (DC) module 300 also allows a user to change user preferences for the dialog. Specifically, the user interface 1000 represents the User Interface module 400 which passes user requests to the Dialog Control (DC) module 300 and waits for the Dialog Control (DC) module 300 processing results. In embodiments, the communication with User Interface is limited to request object and information about modified screen elements.

In block 1002, the user may change user preferences for the Dialog Control (DC) module 300. This may include changing the query interpretation method (extract phrases, AND, OR), choosing another Implementation Layer 1004 and the like.

In block 1004 of FIG. 10, the query may be processed. In function block 1006, the Dialog Control (DC) module 300 abstracts the whole user query processing, i.e., parsing it, interpreting, finding the results and returning them to the User Interface. In this manner, and as an example, the User Interface 1000 sends a request to the Dialog Control Abstract Layer where the request is translated to an event. The event is recognized and passed to the appropriate Implementation Layer 804 which handles the event and obtains the results. The Abstract Layer 802 passes the results to the User Interface which then displays the results.

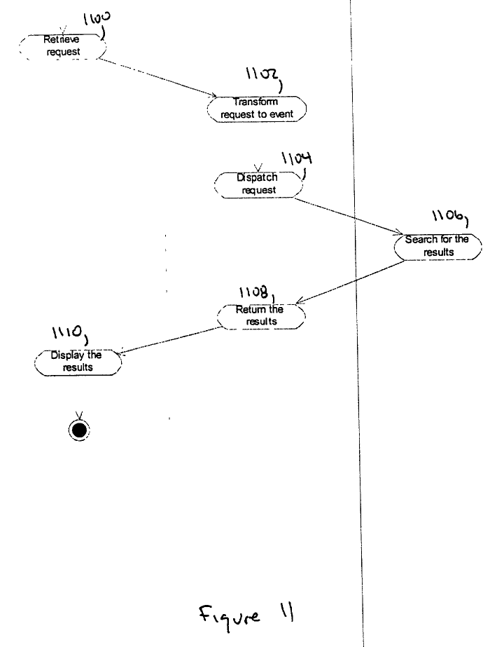

The sequence of events of FIG. 10 is also shown in the flow diagram of FIG. 11.

In step 1100, a request is retrieved via the User Interface. In step 1102, the request is transformed to an event in the Data Control Abstract Layer 902. The query may then be processed. In step 1104, the request is dispatched to the Implementation Layer 904. In the Implementation Layer, a search for the results is provided in step 1106. The results are returned to the Abstract Layer in step 1108 and then displayed via the User Interface in step 1110. It should be noted that the User Interface requests have, in embodiments, the same format; however, the Dialog Control task may be to convert data from the request to an event.

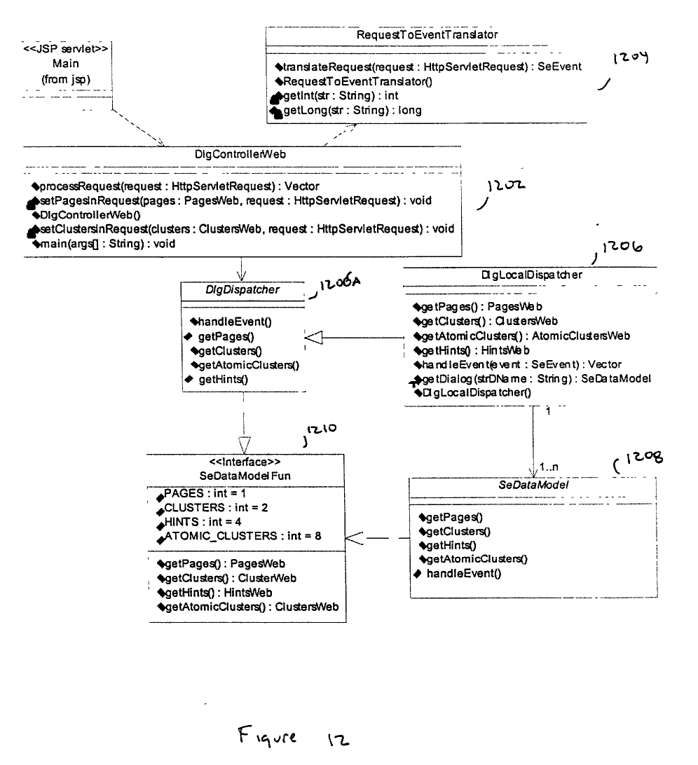

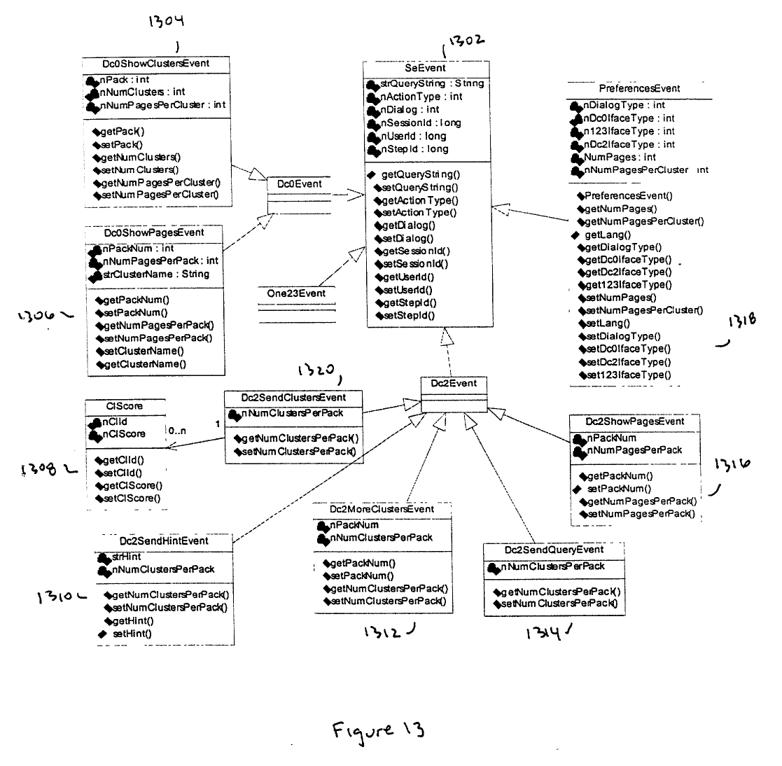

The controller package 310 and the event package 320 of FIG. 5 are discussed with reference to FIGS. 12 and 13. In particular, FIG. 12 shows the class diagram for the controller 310 (com.nutech.se.dc.controller). In FIG. 13, the Class DlgControlerWeb 1202 provides the Data Control (DC) module functionality to User Interface module. Specifically, the Class DlgControlerWeb 1202

uses RequestToEventTranslator class 1204 to translate HttpServletRequest objects from UI module into classes derived from SeEvent classes.

has functions which run search and load result data to HttpServletRequest object.

contains DlgLocalDispatcher objects from block 1206 and block 1206A. This class decodes control information from objects derived from SeEvent class and takes appropriate actions such as, for example, chooses appropriate DCx, provides method to get results and contains objects which represents all search module from system of the present invention.

FIG. 12 also shows SetDataModel 1208 which is an abstract class which defines methods for search modules objects. Classes which represents search modules do not have to implements all methods of SeDataModelFun interface. Also shown in SeDataModelFun 1210 which is an interface which describes methods set of search module classes.

FIG. 13 shows the events package 320 (com.nutech.se.dc.events). The base class for all classes from this package is SeEvent 1302 which contains fields common for other classes. Other classes are derived from the SeEvent class 1302. FIG. 13 further shows the following classes:

Dc0ShowClustersEvent 1304

Dc0ShowPageEvent 1306

ClScore 1308

Dc2SentHintEvent 1310

Dc2MnoreClustersEvent 1312

Dc2SendQueryEvent 1314

Dc2ShowPagesEvent 1316

PreferencesEvent 1318

Dc2SendClustersEvent 1320.

It should be recognized by those of ordinary skill in the art that the class names may vary in both FIGS. 12 and 13. These class names, discussed in further detail below, should thus not be considered a limiting feature of the present invention.

The following is a description of the many classes, methods and attributes shown in FIGS. 12 and 13.

1. com.nutech.se.dc.controller.DlgControllerWeb

Stereotype—class

Implementation DlgControllerWeb.java

Attributes

| Visi- | | | |
|---|---|---|---|
| bilit | Name | Type | Description |
| − | m₋theDlgLocalDis- | DlgLocalDispat | Manages search modules |
| | pather | her | based on information from |
| | | | m₋theRequestToEventTran |
| | | | slator |
| − | m₋theRequestTo- | RequestToEven | Translate |
| | EventTranslator | tTranslator | HttpServletRequest into |
| | | | SeEvent |

Methods

| Visibilit | Signature | Description |
|---|---|---|
| + | processRequest | Action-search or preference |
| | | set depends on passed |
| | | argument |
| − | setPagesInRequest | Puts |
| | | com.nutech.se.ui.dispdata.Pa |
| | | gesWeb object with search |
| | | result in HttpServletRequest |
| | | object |
| − | setClustersInRequest | Puts |
| | | com.nutech.se.ui.dispdata.Cl |
| | | ustersWeb object with search |
| | | results in HttpServletRequest |
| | | object |

2. com.nutech.se.dc.controller.RequestToEventTranslator

Stereotype—class

Implementation RequestToEventTranslator.java

Attribute

| Visibilit | Name | Type | Description |
|---|---|---|---|
| ▪ Methods | | | |

| Visibilit | Signature | Description |
|---|---|---|
| + | translateEvent | Translates HttpServletRequest into |
| | | SeEvent |

3. com.nutech.se.dc.controller.DlgDispatcher

Stereotype—abstract class

Implementation DlgDispatcher.java

Attribute

Methods

| Visibilit | Signature | Description |
|---|---|---|
| + | handleEvent | Empty |
| + | getPages | Empty |
| + | getClusters | Empty |
| + | getAtmicClusters | Empty |
| + | getHints | Empty |

4. com.nutech.se.dc.controller.DlgLocalDispatcher

Stereotype—class

Implementation DlgLocalDispatcher.java

Attribute

| Visibilit | Name | Type | Description |
|---|---|---|---|
| − | m_sdmDialog | SeDataModel | Represents choosen search |
| | | | module |
| | | | (Dialog) |
| − | m_theSeDataM | SeDataModel[ | Set of search modules |
| | odel | ] | |

Methods

| Visibilit | Signature | Description |
|---|---|---|
| + | handleEvent | Search run |
| + | getPages | Object contains founded |
| | | documents (pages) |
| + | getClusters | Returns object with founded |
| | | clusters |
| + | getAtmicClusters | Returns objects with atomic |
| | | clusters |
| + | getHints | Returns hints |

5. com.nutech.se.dc.controller.SeDataModel

Stereotype—abstract class

Implementation SeDataModel.java

Methods

| Visibilit | Signature | Description |
|---|---|---|
| + | handleEvent | empty |
| + | getPages | Empty |
| + | getClusters | Empty |
| + | getAtmicClusters | Empty |
| + | getHints | Empty |

6. com.nutech.se.dc.controller.SeDataModelFun

Stereotype—interface

Implementation SeDataModelFun.java

Attribute

| Visibilit | Name | Type | Description |
|---|---|---|---|
| − | s_PAGES | int | Constant. Shows which part of the |
| | | | screen should be refreshed. |
| − | s_CLUSERS | int | Constant. Shows which part of the |
| | | | screen should be refreshed. |
| − | s_HINTS | int | Constant. Shows which part of the |
| | | | screen should be refreshed. |
| − | s_ATOMIC_HI | int | Constant. Shows which part of the |
| | NTS | | screen should be refreshed. |

Methods

| Visibilit | Signature | Description |
|---|---|---|
| + | handleEvent | empty |
| + | getPages | Empty |
| + | getClusters | Empty |
| + | getAtmicClusters | Empty |
| + | getHints | Empty |

7. com.nutech.se.dc.events.SeEvent

Stereotype—class

Implementation SeEvent.java

Attribute

| Visibilit | Name | Type | Description |
|---|---|---|---|
| − | m_strQueryString | String | User query |
| − | m_nActionType | Integer | action type |
| − | m_nDialog | Integer | Choosen dialog |
| − | m_lSessionId | Long | Session id |
| − | m_lUserId | Long | User id |
| − | m_lStepId | Long | Dialog step number |

Methods

| Visibilit | Signature | Description |
|---|---|---|
| + | String getQueryString() | Returns copy of m_strQueryString |
| + | void setQueryString(String | Sets m_strQueryString |
| | query) | |
| + | int getActionType() | Returns m_nAction value |
| + | void setActionType(int | Sets m_nAction |
| | action) | |
| + | int getDialog() | Returns m_nDialog value |
| + | void setDialog(int dialog) | Sets m_nDialog |
| + | long getSessionId () | Returns m_lSessionId value |
| + | void setSessionId () | Sets m_lSessionId |
| + | long getUserId() | Returns m_lUserId value |
| + | void setUserId() | Sets m_lUserId |
| + | long getStepId() | Returns m_lStepId value |
| + | void setStepId () | Sets m_lStepId |

8. com.nutech.se.dc.events.Dc0ShowClustersEvent

Stereotype—class

Implementation Dc0ShowClustersEvent.java

Attribute

| Visibilit | Name | Type | Description |
|---|---|---|---|
| | m_nPack | int | Returns displayed cluster |
| | | | pack number |
| − | m_nNumClusters | int | Cluster number in package |
| − | m_nNumPagesPerCluster | int | Document number for each |
| | | | cluster |

Methods

| Visibilit | Signature | Description |
|---|---|---|
| + | int getPack() | Returns m_nPack value |
| + | void setPack(int pack) | Sets m_nPack |
| + | int getNumClusters() | Returns m_nNumClusters value |
| + | void setNumClusters (int | Sets m_nNumClusters |
| | numClust) | |
| + | int getNumPagesPerCluster() | Returns m_nNumPagesPerCluster value |
| + | void setNumPagesPerCluster | Sets m_nNumPagesPerCluster |
| | (int pagesPCluster) | |

9. com.nutech.se.dc.events.Dc0ShowPagesEvent

Stereotype—class

Implementation Dc0ShowPagesEvent.java

Attribute

| Visibilit | Name | Type | Desription |
|---|---|---|---|
| − | m_nPackNum | Integer | Document package number |
| − | m_nNumPagesPerPack | Integer | Documents number in |
| | | | package |
| − | m_strClusterName | String | Cluster name |

Methods

| Visibilit | Signature | Description |
|---|---|---|
| + | int getPackNum() | Returns m_nPackNum value |
| + | void setPackNum(int | Sets m_nPackNum |
| | packnum) | |
| + | int getNumPagesPerPack() | Returns m_nNumPagesPerPack |
| | | value |
| + | void setNumPagesPerPack(int | Sets m_nNumPagesPerPack |
| | numppp) | |
| + | String getClusterName() | Returns cluster name |
| + | void setClusterName(String | Sets cluster name |
| | clname) | |

10. com.nutech.se.dc.events.Dc2ShowPagesEvent

Stereotype—class

Implementation Dc2ShowPagesEvent.java

Attribute

| Visibilit | Name | Type | Desription |
|---|---|---|---|
| − | m_nPackNum | Integer | Document package number |
| − | m_nNumPagesPe | Integer | Number of pages per package |
| | rPack | | |

Methods

| Visibilit | Signature | Description |
|---|---|---|
| + | int getPackNum | Returns m_nPackNum value |
| + | void setPackNum | Sets m_nPackNum |
| + | it getNumPagesPerPack | Returns m_nNumPagesPerPack |
| | | value |
| + | void setNumPagesPerPack | Sets m_nNumPagesPerPack |

11. com.nutech.se.dc.events.Dc2MoreClustersEvent

Stereotype—class

Implementation Dc2MoreClustersEvent.java

Attribute

| Visibilit | Name | Type | Desription |
|---|---|---|---|
| − | m_nPackNum | Integer | Cluster package number |
| − | m_nNumClustersPerPa | Integer | Cluster number per package |
| | ck | | |

Methods

| Visibilit | Signature | Description |
|---|---|---|
| + | int getPackNum | Returns m_nPackNum value |
| + | void setPackNum | Sets m_nPackNum |
| + | int | Returns m_nNumClustersPerPack |
| | getNumClustersPerPack | value |
| + | void | Sets m_nNumClustersPerPack |
| | setNumClustersPerPack | |

12. com.nutech.se.dc.events.Dc2SendQueryEvent

Attribute

| Visibilit | Name | Type | Desription |
|---|---|---|---|
| − | m_nNumClustersPerPa | Integer | Number of clusters in |
| | ck | | returned package |

Methods

| Visi- | | |
|---|---|---|
| bilit | Signature | Description |
| + | int getNumClustersPerPack() | Returns m_nNumClustersPerPack |
| | | value |
| + | void setNumClustersPerPack | Sets m_nNumClustersPerPack |
| | (intncpp) | |

13. com.nutech.se.dc.events.Dc2SendHintEvent

Stereotype—class

Implementation—Dc2SendHint.java

Attribute

| Visibilit | Name | Type | Description |
|---|---|---|---|
| − | m_strHint | String | Selected hints name |
| − | m_nNumClustersPer | Integer | Cluster number returned in |
| | Pack | | package |

Methods

| Visi- | | |
|---|---|---|
| bilit | Signature | Description |
| + | String getHint () | Returns m_strHint value |
| + | void setHint (String hint) | Sets m_strHint |
| + | int getNumClustersPerPack() | Returns m_nNumClustersPerPack |
| | | value |
| + | void | Sets m_nNumClustersPerPack |
| | setNumClustersPerPack(int | |
| | ncpp) | |

14. com.nutech.se.dc.events.Dc2SendClustersEvent

Stereotype—class

Implementation Dc2SendClustersEvent.java

Attribute

| Visi- | | | |
|---|---|---|---|
| bilit | Name | Type | Desription |
| − | m_nNumClustersPerPa | Integer | Cluster number in returned |
| | ck | | package |
| − | m_theClScore | ClScore[ | Cluster score for dc2 |
| | | ] | |

Methods

| Visibilit | Signature | Description |
|---|---|---|
| + | ClScore getClScore (int idx) | Returns object value with idx id |
| + | void setClScore (ClScore score, | Sets m_theClScore |
| | int idx) | |
| + | int getNumClustersPerPack() | Returns m_nNumClustersPerPack value |
| + | void setNumClustersPerPack(int | Sets m_nNumClustersPerPack |
| | ncpp) | |

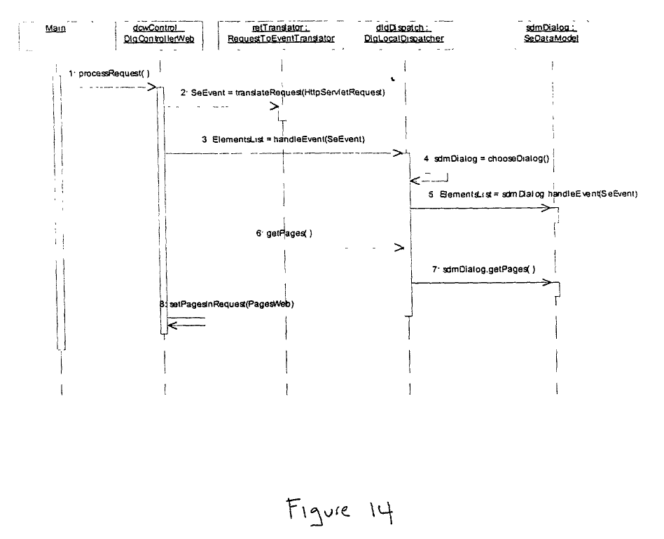

FIG. 14 shows a flow diagram of diagram Interaction Process Request. The following are steps for the flow of FIG. 14:

1. processRequest ( );

2. SeEvent=translateRequest (HttpServerRequest);

3. ElementsList=handleEvent(SeEvent);

4. SdmDialog=chooseDialog ( );

5. ElementsList=sdmDialog.handleEventsd(SeEvent);

6. GetPages( );

7. SdmDialog.getPages( ); and

8. SetPagesInRequest(PagesWeb).

User Interface Module

The User Interface module 400 comprises a set of interactive graphical user interface web-frames. The graphical representation may be dynamically constructed using as many clusters of data as are identified for each search. The display of information may include labeled bars, i.e., “Selection”, “Navigation” and “Options”. The labeled bars are preferably drop-down controls which allow the user to enter or select various controls, options or actions for using the engine. By way of example,

The “Selection” bar allows user entry and specification of compound search criteria with the possibility of defining either mutually exclusive or inclusive logical conditions for each argument. The user may select or deselect any cluster by clicking on a plus or minus sign that will appear next to each cluster of information.

The “Navigation” bar allows the user access to familiar controls such as “forward” or “backward”, print a page, return to home, add a page to favorites and the like.

The “Options” bar presents a drop down list or controls allowing the user to specify the context of the graphical depiction, e.g., magnify images playback control for playing sound (midi, wav, etc.) files, and other options that will determine the look and feel of the user interface.

In one preferred embodiment, the platform for the database is Oracle 8I and running on either Windows NT 4.0 Server or Oracle 8i Server. The hardware may be an Intel Pentium 400 Mhz/256 MB RAM/3 GB HDD. The web server is implemented using Windows NT 4.0 Server, IIS 4.0 and a firewall is responsible for security of the system. It provides secure access to web servers. The system runs on Windows NT 4.0 Server, Microsoft Proxy 3.

While the invention has been described in terms of several embodiments, those skilled in the art will recognize that the invention can be practiced with modification within the spirit and scope of the appended claims. The following claims are in no way intended to limit the scope of the invention to specific embodiments.

1. A method of searching a document source, comprising the steps of:
providing a query;
creating a query pattern from an analyzed query;
searching the document source for documents which match the query pattern;
dividing the retrieved documents into subsets of similar documents, where each subset of the subsets of similar documents is described in terms of a subset pattern;
providing an ordered list of clusters based on the subset pattern of each subset of similar documents, wherein the ordered list of clusters includes separate clusters which contain similar documents retrieved in response to the query.

2. The method of claim 1, wherein the separate clusters are provided to a user.

3. The method of claim 1, further comprising the step of providing a log for each of the separate clusters.

4. The method of claim 3, wherein the log is provided after the user retrieves one of the separate clusters.

5. The method of claim 4, wherein the user retrieves documents from the clusters.

6. The method of claim 1, wherein the searching includes parsing and interpreting words or documents in the document source.

7. The method of claim 1, wherein the query is transformed into an event.

8. The method of claim 1, wherein the query pattern is Boolean functions built from atomic formulas (words or phrases) where variables are phrases of text.

9. The method of claim 8, wherein each query pattern represents a set of documents, where the query pattern is “true”.

10. The method of claim 9, wherein the query pattern is defined as any set of words

11. The method of claim 1, wherein each cluster of the ordered list of clusters includes a predetermined amount of documents.

12. The method of claim 11, wherein a maximum amount of clusters for viewing by the user is predefined.

13. The method of claim 1, wherein the subset pattern of each subset of similar documents is selected from the group comprising:
(vii) a ‘logical or’ of two patterns;
(viii) a ‘logical and’ of two patterns;
(ix) a ‘logical difference’ of two patterns;
(x) a ‘logical or’ of a pattern and a string;
(xi) a ‘logical and’ of a pattern and a string; or
(xii) a ‘logical difference’ between a pattern and a string.

14. A system for searching a document source, comprising the steps of:
means for analyzing a query means for creating a query pattern;
means for searching the document source for documents which match the query pattern;
means for dividing the retrieved documents into subsets of similar documents, where each subset of the subsets of similar documents is described in terms of a subset pattern;
means for providing an ordered list of clusters based on the subset pattern of each subset of similar documents, wherein the ordered list of clusters includes separate clusters which contain similar documents retrieved in response to the query.

15. The system of claim 14, further comprising means for creating an event from the analyzed query.

16. The system of claim 14, further comprising a means for controlling information from and to a user interface.

17. A machine readable medium containing code for searching a document source, comprising the steps of:
providing a query;
analyzing the query and creating a query pattern from the analyzed query;
searching the document source for documents which match the pattern;
dividing the retrieved documents into subsets of similar documents, where each subset of the subsets of similar documents is described in terms of a subset pattern; providing an ordered list of clusters based on the subset pattern of each subset of similar documents, wherein the ordered list of clusters includes separate clusters which contain similar documents retrieved in response to the query.
